(19) United States
(12) Patent Application Publication
(10) Pub. No.: US 2016/0193671 A1
(43) Pub. Date: Jul. 7, 2016

(54) CUTTING TOOL

(71) Applicant: TOYOTA JIDOSHA KABUSHIKI KAISHA, Toyota-shi, Aichi (JP)

(72) Inventor: Toshitaka KAMIKUBO, Okazaki-shi (JP)

(21) Appl. No.: 14/892,932

(22) PCT Filed: Jun. 3, 2014
(86) PCT No.: PCT/JP2014/002959

§ 371 Date: Nov. 20, 2015

(30) Foreign Application Priority Data
Jul. 24, 2013 (JP) 2013-153289

(51) Int. Cl. B23C 5/10; B23C 5/24

(52) U.S. Cl. CPC B23C 5/109; B23C 5/24; B23C 2210/285

(57) ABSTRACT

In a cutting tool according to an aspect of the present invention, a first cutter and a second cutter are attached to a holder. A projection amount of the first cutter that projects substantially in the horizontal direction from the holder is greater than a projection amount of the second cutter that projects substantially in the horizontal direction from the holder. A cutting resistance of the first cutter to an object to be cut is smaller than a cutting resistance of the second cutter to the object to be cut so that a rotation axis of the cutting tool is disposed at substantially the same position as a center-of-gravity position of a horizontal section of the holder during cutting of the object to be cut while rotating the holder.

### TECHNICAL FIELD

The present invention relates to a cutting tool, and more particularly, to a cutting tool including a plurality of cutters.

### BACKGROUND ART

A cutting tool is used to, for example, form a through-hole in an object to be cut. As disclosed in Patent Literature 1, a plurality of cutters are attached to a holder. In this case, the plurality of cutters are attached to the holder in such a manner that the plurality of cutters project in substantially the horizontal direction from the holder by substantially the same respective amounts.

### CITATION LIST

### Patent Literature

[Patent Literature 1] Japanese Unexamined Patent Application Publication No. 2001-9627

### SUMMARY OF INVENTION

### Technical Problem

In the cutting tool as described above, the plurality of cutters are attached to the holder in such a manner that the plurality of cutters project in substantially the horizontal direction from the holder by substantially the same respective amounts. Accordingly, it is necessary to readjust the respective amounts of projection of all the cutters after replacement of the cutters. This makes it troublesome to adjust the cutters.

The present invention has been made to solve the above-mentioned problem, and an object of the present invention is to provide a cutting tool capable of reducing labor associated with the adjustment of cutters.

### Solution to Problem

A cutting tool according to one aspect of the present invention includes a holder, a first cutter, and a second cutter, the first cutter and the second cutter being attached to the holder. Assuming that a direction perpendicular to a vertical direction in which a side of the cutting tool that is coupled to a drive mechanism corresponds to an upper side of the cutting tool is a horizontal direction, an amount of projection of the first cutter that projects substantially in the horizontal direction from the holder is greater than an amount of projection of the second cutter that projects substantially in the horizontal direction from the holder. A cutting resistance of the first cutter to an object to be cut is smaller than a cutting resistance of the second cutter to the object to be cut so that a rotation axis of the cutting tool is disposed at substantially the same position as a center-of-gravity position of a horizontal section of the holder during cutting of the object to be cut while rotating the holder.

In the cutting tool described above, it is preferable that a material of the first cutter have a surface with a lower friction than that of a material of the second cutter.

In the cutting tool described above, it is preferable that an inclination angle of the second cutter in a circumferential direction of the holder be greater in a negative direction of a rotation direction of the holder than an inclination angle of the first cutter in the circumferential direction of the holder.

A cutting tool according to another aspect of the present invention includes a holder, a first cutter, and a second cutter, the first cutter and the second cutter being attached to the holder. Assuming that a direction perpendicular to a vertical direction in which a side of the cutting tool that is coupled to a drive mechanism corresponds to an upper side of the cutting tool is a horizontal direction, an amount of projection of the first cutter that projects substantially in the horizontal direction from the holder is greater than an amount of projection of the second cutter that projects substantially in the horizontal direction from the holder. A guide pad is attached to the holder in the vicinity of the second cutter so that a rotation axis of the cutting tool is disposed at substantially the same position as a center-of-gravity position of a horizontal section of the holder during cutting of an object to be cut while rotating the holder.

The cutting tool described above may include an adjustment mechanism to adjust an amount of projection of the first cutter from the holder, and may include no adjustment mechanism to adjust an amount of projection of the second cutter from the holder.

### Advantageous Effects of Invention

As described above, it is possible to provide a cutting tool capable of reducing labor associated with the adjustment of cutters.

### BRIEF DESCRIPTION OF DRAWINGS

FIG. 1 is a front elevational view schematically showing a state in which a cutting tool according to a first embodiment is coupled to a rotational driving mechanism of a cutting device;

FIG. 2 is a bottom view schematically showing the cutting tool according to the first embodiment;

FIG. 3 is a perspective view schematically showing a holder of the cutting tool according to the first embodiment when the holder is turned upside down and viewed from above;

FIG. 4 is a view schematically showing the holder viewed in a direction indicated by IX in FIG. 3;

FIG. 5 is a perspective view schematically showing a cartridge in the cutting tool according to the first embodiment;

FIG. 6 is a view schematically showing the cartridge viewed in a direction indicated by VI in FIG. 5;

FIG. 7 is a view schematically showing the holder in a direction indicated by VII in FIG. 3;

FIG. 8 is a bottom view schematically showing a cutting tool according to a second embodiment;

FIG. 9 is a front elevational view schematically showing a cutting tool according to a third embodiment; and

FIG. 10 is a bottom view schematically showing the cutting tool according to the third embodiment.

### DESCRIPTION OF EMBODIMENTS

Best modes for carrying out the present invention will be described below with reference to the accompanying drawings. However, the present invention is not limited to the following embodiments. To clarify the explanation, the following description and the drawing are simplified as appropriate. In the following description, it is assumed that the side of a cutting device that is coupled to a rotational driving mechanism corresponds to the upper side of the cutting device. However, the directions are changed as needed depending on the type of usage of a cutting tool.

### First Embodiment

A cutting tool according to this embodiment will be described. First, a basic form of the cutting tool according to this embodiment will be described. The cutting tool according to this embodiment can be used to, for example, form a through-hole in an object to be cut.

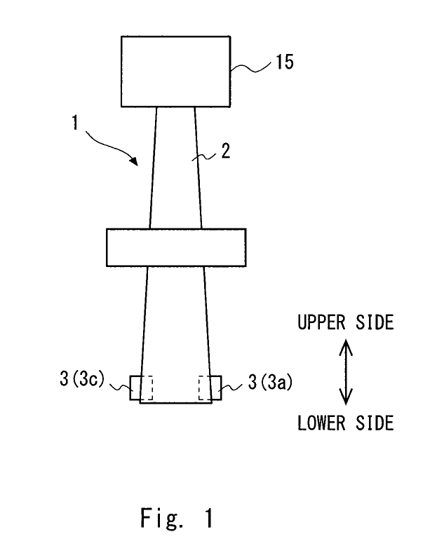

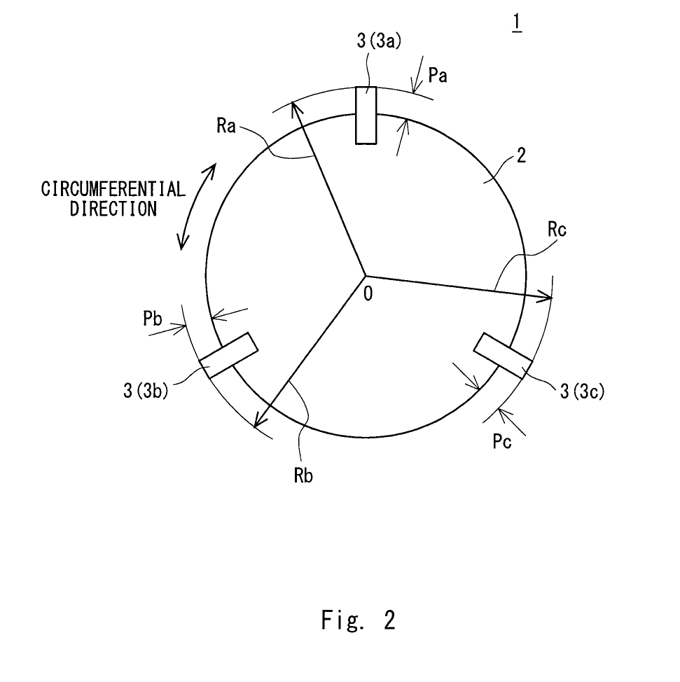

FIG. 1 is a front elevational view schematically showing a state in which a cutting tool 1 according to this embodiment is coupled to a rotational driving mechanism of a cutting device. FIG. 2 is a bottom view schematically showing the cutting tool 1 according to this embodiment. As shown in FIGS. 1 and 2, the cutting tool 1 includes a holder 2 and cutters 3.

As shown in FIGS. 1 and 2, the basic form of the holder 2 is a substantially conical shape. For example, an upper end of the holder 2 is coupled to a rotation axis of a rotational driving mechanism 15 of the cutting device. The cutters 3 are attached to a lower end of the holder 2 in the circumference direction thereof.

This holder 2 is made of, for example, steel. The holder 2 may have any shape as long as the shape allows the formation of a through-hole in the object to be cut. For example, a horizontal section of the holder 2 may have a polygonal shape. The holder 2 may be made of any material as long as the material can satisfactorily transmit a driving force of the rotational driving mechanism 15 to the cutters 3.

As shown in FIGS. 1 and 2, the cutters 3 are attached to a lower end of the holder 2 in such a manner that the cutters 3 project from the holder 2 in the radial direction of the holder 2. In this embodiment, three cutters 3 (3a, 3b, and 3c) are arranged substantially at regular intervals in the circumferential direction of the holder 2. The cutters 3a, 3b, and 3c are arranged at substantially the same mounting angle (for example, at a rake angle of 0°). However, the cutters 3 need not necessarily be arranged substantially at regular intervals in the circumferential direction of the holder 2.

As shown in FIG. 2, a projection amount Pa of the cutter 3a that projects from the holder 2 in the radial direction of the holder 2 (i.e., projects from the holder 2 substantially in a horizontal direction) is greater than projection amounts Pb and Pc of the cutters 3b and 3c that project from the holder 2 in the radial direction oft the holder 2. Specifically, a distance Ra from a center-of-gravity position (center) O of a horizontal section of the holder 2 to a leading end of the cutter 3a is longer than a distance Rb from the center O of the holder 2 to a leading end of the cutter 3b, and is also longer than a distance Rc from the center O of the holder 2 to a leading end of the cutter 3c.

In this case, when the projection amount Pa of the cutter 3a that projects from the holder 2 in the radial direction of the holder 2 is greater than the projection amounts Pb and Pc of the cutters 3b and 3c that project from the holder 2 in the radial direction of the holder 2, and, for example, when the cutters 3a, 3b, and 3c are made of the same material and the cutters 3a, 3b, and 3c are mounted at the same mounting angle (for example, at a rake angle of 0°), the cutting resistance of the cutter 3a is larger than the cutting resistance of the cutters 3b and 3c. As a result, the rotation axis of the cutting tool 1 during cutting of the object to be cut deviates from the center O of the holder 2.

Therefore, in this embodiment, the cutter 3a is made of a material having a surface with a lower friction than that of the material of the cutters 3b and 3c so that the rotation axis of the cutting tool 1 during cutting of the object to be cut is disposed at substantially the same position as the center O of the holder 2. For example, a diamond chip is used as the cutter 3a and a carbide chip is used as each of the cutters 3b and 3c.

With this structure, the cutting resistance of the cutters 3b and 3c can be increased as compared with the cutting resistance of the cutter 3a. As a result, the projection amount Pa of the cutter 3a that projects from the holder 2 in the radial direction of the holder 2 is set to be greater than the projection amounts Pb and Pc of the cutters 3b and 3c that project from the holder 2 in the radial direction of the holder 2, thereby counteracting the phenomenon in which the cutting resistance of the cutter 3a is larger than the cutting resistance of the cutters 3b and 3c. Consequently, the rotation axis of the cutting tool 1 during cutting of the object to be cut can be disposed at substantially the same position as the center O of the holder 2. In other words, the center of a through-hole formed in the object to be cut and the rotation axis of the cutting tool 1 can be disposed at substantially the same position.

When the cutters 3a, 3b, and 3c are attached to the holder 2 in the cutting tool 1 according to this embodiment, the cutter 3a is attached to the holder 2 in such a manner that the projection amount Pa of at least the cutter 3a that projects from the holder 2 in the radial direction of the holder 2 matches the diameter of a through-hole formed in the object to be cut. Thus, a through-hole having a desired diameter can be formed in the object to be cut. In other words, a through-hole having a desired diameter can be formed in the object to be cut, without the need for performing a high-precision adjustment for the projection amounts Pb and Pc of the cutters 3b and 3c that project from the holder 2 in the radial direction of the holder 2. This makes it possible to reduce labor associated with the adjustment of the cutters.

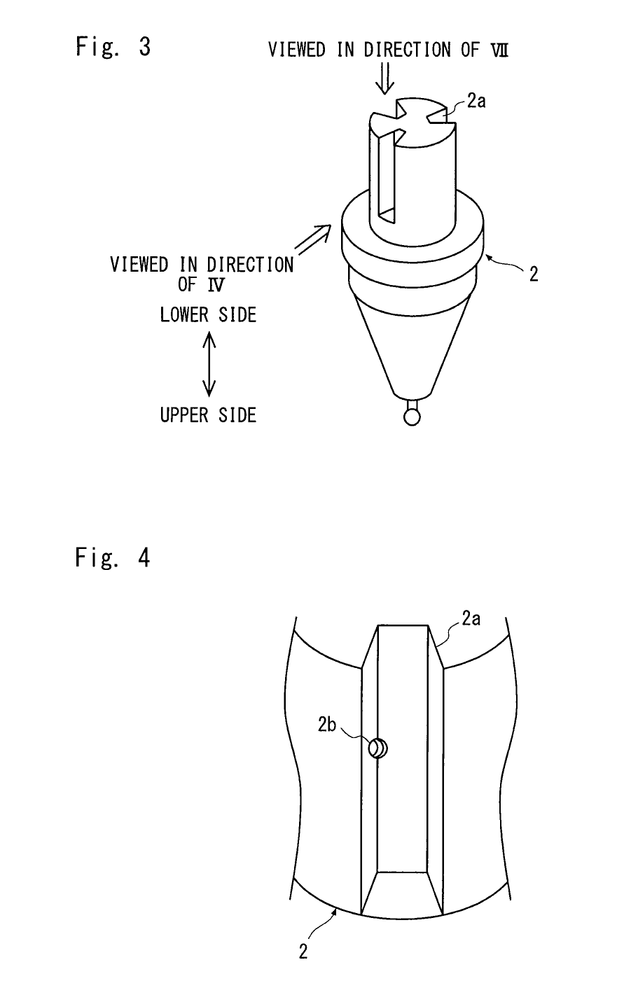

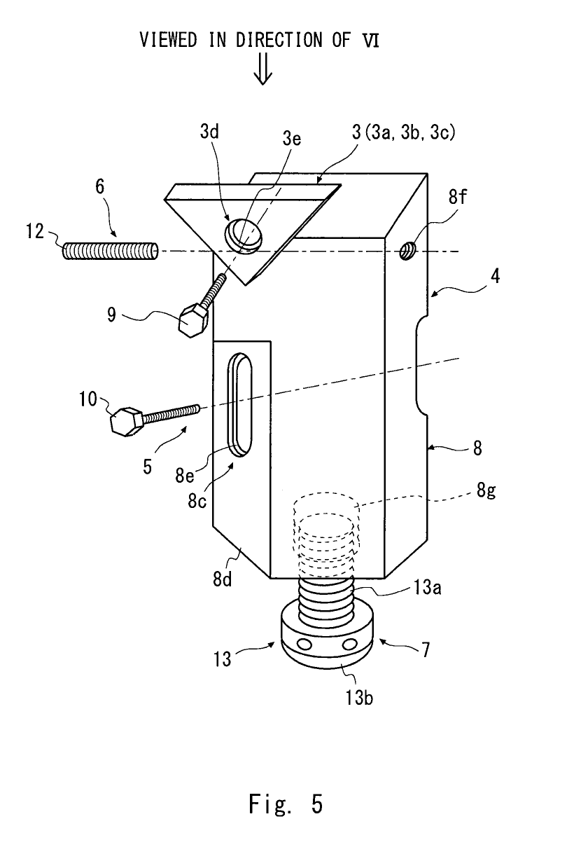

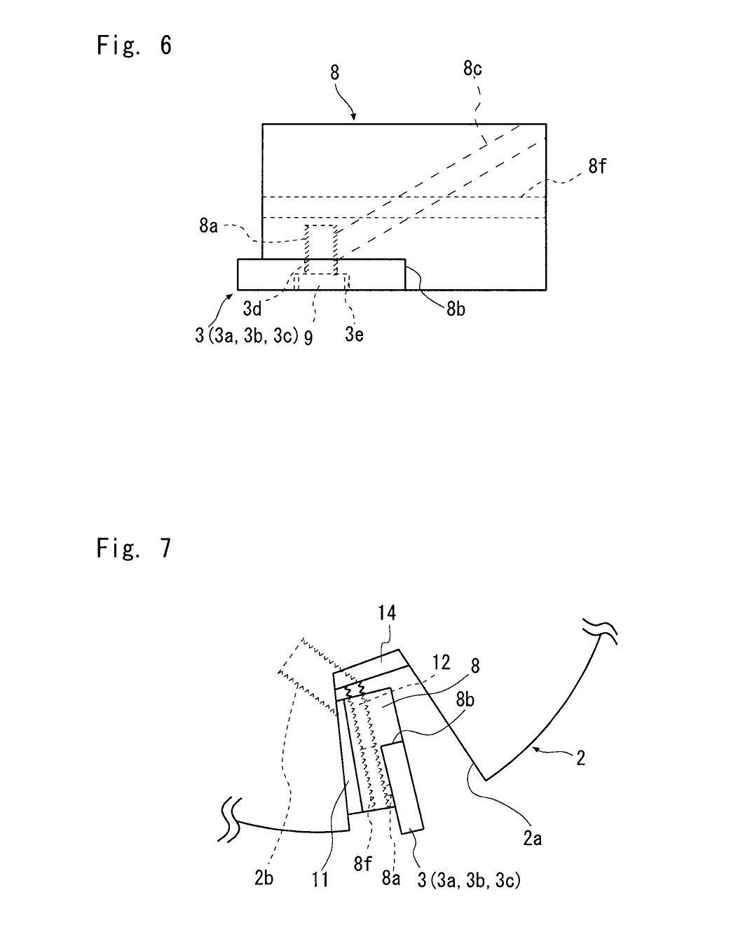

Next, a specific structure of the cutting tool 1 according to this embodiment will be described. FIG. 3 is a perspective view schematically showing the holder 2 when the holder 2 is turned upside down and viewed from above. FIG. 4 is a view schematically showing the holder viewed in a direction indicated by IV in FIG. 3. FIG. 5 is a perspective view schematically showing a cartridge. FIG. 6 is a view schematically showing the cartridge viewed in a direction indicated by VI in FIG. 5. FIG. 7 is a view schematically showing the holder viewed in a direction indicated by VII in FIG. 3.

As shown in FIG. 3, an upper portion of the holder 2 according to this embodiment is formed in a substantially conical shape, and a lower portion of the holder 2 is formed in a substantially columnar shape. The center-of-gravity position of the horizontal section of the upper portion of the holder 2 and the center-of-gravity position of the horizontal section of the lower portion of the holder 2 are disposed at substantially the same position when viewed in the vertical direction.

In the lower portion of the holder 2, grooves 2a are formed at intervals in the circumferential direction of the holder 2. In this embodiment, three grooves 2a are disposed substantially at regular intervals in the circumferential direction of the holder 2. These grooves 2a each have an opening formed at the lower side of the holder 2 and in the radial direction thereof, and the longitudinal direction of the grooves 2a extends substantially in the vertical direction of the holder 2. These openings are formed so as to expand outward from the center of the holder 2.

As shown in FIG. 4, a bolt hole 2b is formed in the vicinity of a bottom portion of the groove 2a. As shown in FIG. 7, the bolt hole 2b according to this embodiment is disposed so as to be inclined in the radial direction of the holder 2 in the vicinity of a corner portion of the bottom portion of the groove 2a when viewed in the vertical direction. However, the bolt hole 2b may be disposed at any position, as long as the bolt hole 2b is disposed at a position where a cartridge 4, which is described later, can be fixed satisfactorily.

The cartridge 4 is disposed in the groove 2a of the holder 2 and is attached to the holder 2 with a bolt. The structure of the cartridge 4 will now be described. As shown in FIG. 5, the cartridge 4 includes a mounting mechanism 5 that allows the cutters 3 to be attached to the holder 2; a projection amount adjustment mechanism 6 that adjusts the projection amounts of the cutters 3 that project in the radial direction of the holder 2; and a height adjustment mechanism 7 that adjusts the positions of the cutters 3 in the vertical direction of the holder 2.

As the cartridge 4 of this embodiment, a cartridge to which the cutter 3a is attached, a cartridge to which the cutter 3b is attached, and a cartridge to which the cutter 3c is attached are prepared. The cutters 3 are thin and have a triangular prism shape, and a through-hole 3d is formed so as to penetrate through the triangular surfaces opposed to each other. In this regard, however, general cutter shapes can be adopted as the shapes of the cutters 3.

The mounting mechanism 5 allows the cutters 3 to be attached to the holder 2 through a cartridge body 8. As shown in FIG. 5, the basic form of the cartridge body 8 of this embodiment is a substantially prism shape. As shown in FIG. 6, a bolt hole 8a into which a bolt 9 for mounting the cutters 3 is formed at a lower end of the cartridge body 8.

This bolt hole 8a and the through-hole 3d of each cutter 3 are aligned, and the bolt 9 is screwed into the bolt hole 8a through the through-hole 3d of each cutter 3, thereby allowing the cutters 3 to be attached to the cartridge body 8. In this case, a corner portion of each cutter 3 projects laterally from the cartridge body 8.

It is preferable that the cartridge body 8 have a notch 8b formed therein so that a part of each cutter 3 is fit into the notch. With this structure, the alignment of the cutters 3 can be easily performed merely by fitting each cutter 3 into the notch 8b of the cartridge body 8.

It is also preferable that a counterbore portion 3e be formed in the vicinity of the through-hole 3d of each cutter 3. With this structure, the bolt head of the bolt 9 can be accommodated in the counterbore portion 3e of each cutter 3.

As shown in FIG. 5, the cartridge body 8 has a through-hole 8c through which a bolt 10 for attaching the cartridge 4 to the holder 2 passes. As shown in FIGS. 5 to 7, the through-hole 8c is disposed so as to be inclined when viewed in the vertical direction so that the bolt 10 can be screwed into the bolt hole 2b of the holder 2 through the cartridge body 8 in a state where a side surface of the cartridge body 8 is brought into contact with a side surface of the groove 2a of the holder 2 through a washer 11. The through-hole 8c is formed in such a manner that a movement of the cartridge 4 in the vertical direction is allowed and a movement of the cartridge 4 in the radial direction of the holder 2 is also allowed.

This through-hole 8c and the bolt hole 2b of the holder 2 are aligned, and the bolt 10 is screwed into the bolt hole 2b of the holder 2 through the through-hole 8c of the cartridge body 8, thereby allowing the cartridge 4 to be attached to the holder 2. In this case, the rake angle of the cutter 3a is, for example, about 0°.

As shown in FIG. 5, a notch 8d which is disposed substantially parallel to the bearing surface of the bolt 10 is preferably formed in the cartridge body 8 so that the bearing surface of the bolt 10 is satisfactorily brought into surface contact with the cartridge body 8. With this structure, the cartridge 4 can be firmly attached to the holder 2 with the bolt 10.

It is also preferable that the notch 8d have a counterbore portion 8e in which the bolt head of the bolt 10 is accommodated.

The projection amount adjustment mechanism 6 adjusts the projection amount of a hexagon socket head cap screw 12, which is screwed into a bolt through-hole 8f of the cartridge body 8, thereby adjusting the projection amount of the cutters 3 that project from the holder 2 in the radial direction of the holder 2.

As shown in FIG. 6, the bolt through-hole 8f is formed in the cartridge body 8 in such a manner that the bolt through-hole 8f is substantially parallel to the opposed triangular surfaces of the cutters 3 when viewed in the vertical direction, and penetrates through the cartridge body 8.

The hexagon socket head cap screw 12 is screwed into the bolt through-hole 8f, and a leading end of the hexagon socket head cap screw 12 is allowed to project from the cartridge body 8 and is brought into contact with the groove 2a of the holder 2, thereby defining the projection amount of each cutter 3 that projects from the holder 2 in the radial direction of the holder 2. In this case, the projection amount of each cutter 3 that projects from the holder 2 in the radial direction of the holder 2 is adjusted by changing the projection amount of the leading end of the hexagon socket head cap screw 12.

The height adjustment mechanism 7 adjusts the projection amount of a height adjustment piece 13, which is screwed into a bolt hole 8g of the cartridge body 8, thereby adjusting the position of each cutter 3 in the vertical direction. The bolt hole 8g is formed in an upper surface of the cartridge body 8, and extends in the vertical direction. The height adjustment piece 13 includes a bar screw portion 13 that extends in the vertical direction, and a contact portion 13b that is formed at a leading end of the bar screw portion 13a.

When the cartridge 4 is attached to the holder 2 by screwing the bar screw portion 13a into the bolt hole 8g of the cartridge body 8, the contact portion 13b is brought into contact with an upper surface of the groove 2a of the holder 2, thereby defining the position of each cutter 3 in the vertical direction. In this case, the position of each cutter 3 in the vertical direction is adjusted by changing the screw-in amount of the bar screw portion 13a into the bolt hole 8g of the cartridge body 8.

Next, the process of attaching the cutter 3a to the holder 2 will be described. First, the bolt hole 8a of the cartridge body 8 and the through-hole 3d of the cutter 3a are aligned, and the bolt 9 is screwed into the bolt hole 8a through the through-hole 3d of the cutter 3a. Then, the bar screw portion 13a of the height adjustment piece 13 is screwed by a predetermined length into the bolt hole 8g of the cartridge body 8. In this manner, the cartridge 4 shown in FIG. 5 is formed.

Next, as shown in FIG. 7, the washer 11 is disposed between the cartridge 4 and a side surface of the groove 2a of the holder 2, and a washer 14 is disposed between the cartridge 4 and the bottom surface of the groove 2a of the holder 2. Further, the cartridge 4 is disposed within the groove 2a of the holder 2. At this time, the screw-in amount of the bar screw portion 13a of the height adjustment piece 13 into the bolt hole 8g of the cartridge body 8 is adjusted in a state where the contact portion 13b of the height adjustment piece 13 is in contact with the upper surface of the groove 2a of the holder 2, thereby adjusting the position of the cutter 3a in the vertical direction.

Next, the hexagon socket head cap screw 12 is screwed into the bolt through-hole 8f of the cartridge body 8, and the leading end of the hexagon socket head cap screw 12 is allowed to project form the cartridge body 8 and is brought into contact with the washer 14. At this time, the screw-in amount of the hexagon socket head cap screw 12 is adjusted to thereby adjust the projection amount of the cutter 3a that projects from the holder 2 in the radial direction of the holder 2.

Next, the bolt 10 is allowed to pass through the through-hole 8c of the cartridge body 8 and the bolt 10 is screwed into the bolt hole 2b of the holder 2. Thus, the process of attaching the cartridge 4 to the holder 2 is finished. It is preferable that the cartridge 4 be attached to the holder 2 in the vicinity of each cutter 3 so as to prevent a positional deviation of the leading end of each cutter 3.

In the manner as described above, the cartridge 4 to which the cutter 3b is attached and the cartridge 4 to which the cutter 3c is attached are attached to the holder 2. In this case, as described above, the projection amounts Pb and Pc of the cutters 3b and 3c that project from the holder 2 in the radial direction of the holder 2 are adjusted in such a manner that the projection amounts Pb and Pc are smaller than the projection amount Pa of the cutter 3a that projects from the holder 2 in the radial direction of the holder 2.

In this embodiment, the cartridge 4 to which the cutter 3b is attached and the cartridge 4 to which the cutter 3c is attached include the projection amount adjustment mechanism 6. However, it is only necessary that these cartridges 4 be attached in such a manner that the projection amounts Pb and Pc of the cutters 3b and 3c that project from the holder 2 in the radial direction of the holder 2 are smaller than the projection amount Pa of the cutter 3a that projects from the holder 2 in the radial direction of the holder 2, and there is no need for performing a high-precision adjustment for the projection amounts. Therefore, the projection amount adjustment mechanism 6 may be omitted. This leads to a simplification of the structure of the cutting tool 1.

### Second Embodiment

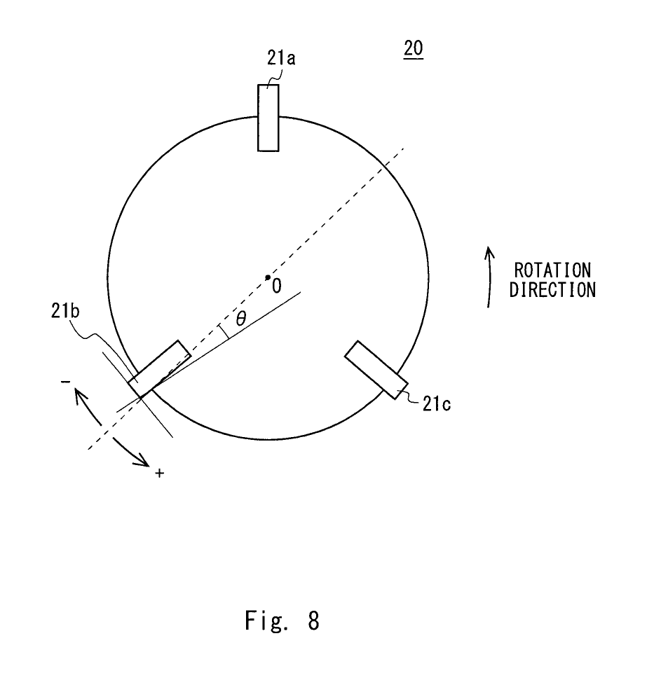

In a cutting tool 20 according to this embodiment, cutters 21a, 21b, and 21c are made of the same material. FIG. 8 is a bottom view schematically showing the cutting tool 20 of this embodiment. The cutting tool 20 of this embodiment has substantially the same structure as that of the cutting tool 1 of the first embodiment, and thus a repeated description thereof will be omitted. Elements of the cutting tool 20 that are identical to the elements of the cutting tool 1 are denoted by the same reference numerals.

As described above, when the projection amount Pa of the cutter 21a that projects from the holder 2 in the radial direction of the holder 2 is greater than the projection amounts Pb and Pc of the cutters 21b and 21c that project from the holder 2 in the radial direction of the holder 2; the cutters 21a, 21b, and 21c are made of substantially the same material; and the cutters 21a, 21b, and 21c are arranged at substantially the same mounting angle, the cutting resistance of the cutter 21a is larger than the cutting resistance of the cutters 21b and 21c. As a result, the rotation axis of the cutting tool 20 during cutting of an object to be cut deviates from the center O of the holder 2.

Therefore, in this embodiment, the inclination angle of each of the cutters 21b and 21c in the circumferential direction of the holder 2 is set to be greater in the negative direction of the rotation direction of the holder 2 than the inclination angle of the cutter 21a in the circumferential direction of the holder 2 so that the rotation axis of the cutting tool 20 during cutting of the object to be cut is disposed substantially at the same position as the center O of the holder 2. In other words, a rake angle θ of each of the cutters 21b and 21c is greater in the negative direction than that of the cutter 21a.

For example, the rake angles θ of the cutters 21b and 21c may be increased in the negative direction and the rake angle θ of the cutter 21a may be set to 0°. Alternatively, the rake angles θ of the cutters 21b and 21c may be set to 0° and the rake angle θ of the cutter 21a may be increased in the positive direction. More alternatively, the rake angles θ of all the cutters 21a, 21b, and 21c may be increased in the negative direction, and the rake angles θ of the cutters 21b and 21c may be set to be greater in the negative direction than the rake angle θ of the cutter 21a. In a further alternative, the rake angle θ of the cutter 21a may be increased in the positive direction and the rake angles θ of the cutters 21b and 21c may be increased in the negative direction. In this case, the rake angles θ of the cutters 21b and 21c need not necessarily be the same.

With this structure, the cutting resistance of the cutters 21b and 21c can be increased as compared with the cutting resistance of the cutter 21a. As a result, the projection amount Pa of the cutter 21a that projects from the holder 2 in the radial direction of the holder 2 is set to be greater than the projection amounts Pb and Pc of the cutters 21b and 21c that project from the holder 2 in the radial direction of the holder 2, thereby counteracting the phenomenon in which the cutting resistance of the cutter 21a is larger than the cutting resistance of the cutters 21b and 21c. Consequently, the rotation axis of the cutting tool 20 during cutting of the object to be cut can be disposed at substantially the same position as the center O of the holder 2. In other words, the center of a through-hole formed in the object to be cut and the rotation axis of the cutting tool 1 can be disposed at substantially the same position.

### Third Embodiment

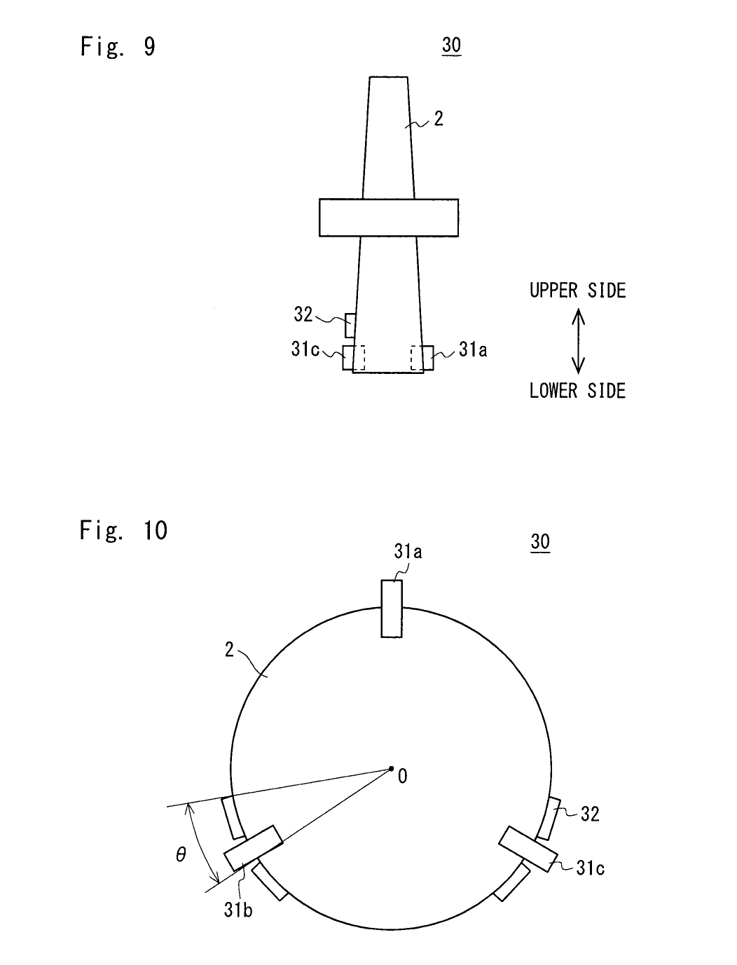

In a cutting tool 30 according to this embodiment, cutters 31a, 31b, and 31c are made of the same material. FIG. 9 is a front elevational view schematically showing the cutting tool 30 according to this embodiment. FIG. 10 is a bottom view schematically showing the cutting tool 30 according to this embodiment. The cutting tool 30 of this embodiment has substantially the same structure as that of the cutting tool 1 of the first embodiment, and thus a repeated description thereof will be omitted. Elements of the cutting tool 30 that are identical to the elements of the cutting tool 1 are denoted by the same reference numerals.

As described above, when the projection amount Pa of the cutter 31 a that projects from the holder 2 in the radial direction of the holder 2 is greater than the projection amounts Pb and Pc of the cutters 31b and 31c that project from the holder 2 in the radial direction of the holder 2; the cutters 31a, 31b, and 31c are made of substantially the same material; and the cutters 31a, 31b, and 31c are arranged at substantially the same mounting angle, the cutting resistance of the cutter 31a is larger than the cutting resistance of the cutters 31b and 31c. As a result, the rotation axis of the cutting tool 30 during cutting of an object to be cut deviates from the center O of the holder 2.

Therefore, in this embodiment, guide pads 32 are disposed in the vicinity of the cutters 31b and 31c so that the rotation axis of the cutting tool 30 during cutting of the object to be cut is disposed at substantially the same position as the center O of the holder 2.

The guide pads 32 are disposed so as to sandwich the cutters 31b and 31c in the circumferential direction of the holder 2 when viewed in the vertical direction, for example, so as to prevent the cutters 31b and 31c from being pressed into the object to be cut and from being deformed during cutting of the object to be cut. The guide pads 32 are disposed above the cutters 31b and 31c so that the guide pads 32 complete the process of contacting the object to be cut before the cutters 31a, 31b, and 31c contact the object to be cut, when the cutting tool 30 is pulled out after the formation of a through-hole in the object to be cut.

Surfaces of these guide pads 32 that face the holder 2 are formed so as to correspond to the outer peripheral shape of the holder 2. In other words, the surfaces of the guide pads 32 are formed in contact with the holder 2. Surfaces of the guide pads 32 opposite to the surfaces thereof facing the holder 2 are each formed in a curved surface.

The thickness of each guide pad 32 is set in such a manner that the distance from the center of the holder 2 to the surface of the guide pad 32 opposite to the surface thereof facing the holder 2 is shorter than any one of a distance Ramin from the center of the holder 2 to the leading end of the cutter 31a, the projection amount of which is adjusted to a minimum value, the distance Rb from the center of the holder 2 to the leading end of the cutter 31b, and the distance Rc from the center of the holder 2 to the leading end of the cutter 31c. That is, the guide pads 32 do not project with respect to the leading ends of the cutters 31a, 31b, and 31c from the holder 2 in the radial direction of the holder 2.

These guide pads 32 are each made of, for example, artificial diamond or brass, and are attached to the holder 2 by fixing means such as a bolt.

With this structure, the guide pads 32 can receive a force that presses the cutting tool in the direction of the cutters 31b and 31c due to cutting of the object to be cut by the cutter 31a, and the rotation axis of the cutting tool 30 during cutting of the object to be cut can be disposed at substantially the same position as the center O of the holder 2. In other words, the center of a through-hole formed in the object to be cut and the rotation axis of the cutting tool 30 can be disposed at substantially the same position.

Embodiments of the present invention have been described above. However, the present invention is not limited to the above embodiments and can be modified without departing from the technical idea of the present invention. For example, a cutting tool may be formed using any combination of the first to third embodiments.

The cutting tools according to the embodiments described above include three cutters. However, the number of cutters is not limited as long as a plurality of cutters are provided.

In the above embodiments, only the cutter 3a is allowed to project from the holder 2 in the radial direction of the holder 2 with respect to the other cutters 3b and 3c. However, it is only necessary that at least one cutter is allowed to project from the holder 2 in the radial direction of the holder 2 with respect to the other cutters.

This application is based upon and claims the benefit of priority from Japanese patent application No. 2013-153289, filed on Jul. 24, 2013, the disclosure of which is incorporated herein in its entirety by reference.

### INDUSTRIAL APPLICABILTIY

The present invention is applicable as a cutting tool including a plurality of cutters.

### REFERENCE SIGNS LIST

1 CUTTING TOOL
2

HOLDER
2a GROOVE
2b BOLT HOLE
3 (3a, 3b, 3c) CUTTER
3d THROUGH-HOLE
3e COUNTERBORE PORTION
4 CARTRIDGE
5 MOUNTING MECHANISM
6 PROJECTION AMOUNT ADJUSTMENT MECHANISM
7 ADJUSTMENT MECHANISM
8 CARTRIDGE BODY
8a BOLT HOLE
8b NOTCH
8c THROUGH-HOLE
8d NOTCH
8e COUNTERBORE PORTION
8f BOLT THROUGH-HOLE
8g BOLT HOLE
9, 10 BOLT
11, 14 WASHER
12 HEXAGON SOCKET HEAD CAP SCREW
13 ADJUSTMENT PIECE
13a BAR SCREW PORTION
13b CONTACT PORTION
15 ROTATIONAL DRIVING MECHANISM
20 CUTTING TOOL
21a, 21b, 21c CUTTER
30 CUTTING TOOL
31a, 31b, 31c CUTTER
32 GUIDE PAD
O CENTER OF HOLDER
Pa, Pb, Pc PROJECTION AMOUNT OF CUTTER
Ra, Rb, Rc DISTANCE FROM CENTER OF HOLDER TO LEADING END OF
CUTTER
θ RAKE ANGLE

1. A cutting tool comprising a holder, a first cutter, and a second cutter, the first cutter and the second cutter being attached to the holder, wherein
assuming that a direction perpendicular to a vertical direction in which a side of the cutting tool that is coupled to a drive mechanism corresponds to an upper side of the cutting tool is a horizontal direction, an amount of projection of the first cutter that projects substantially in the horizontal direction from the holder is greater than an amount of projection of the second cutter that projects substantially in the horizontal direction from the holder, and
a cutting resistance of the first cutter to an object to be cut is smaller than a cutting resistance of the second cutter to the object to be cut so that a rotation axis of the cutting tool is disposed at substantially the same position as a center-of-gravity position of a horizontal section of the holder during cutting of the object to be cut while rotating the holder.

2. The cutting tool according to claim 1, wherein a material of the first cutter has a surface with a lower friction than that of a material of the second cutter.

3. The cutting tool according to claim 1, wherein an inclination angle of the second cutter in a circumferential direction of the holder is greater in a negative direction of a rotation direction of the holder than an inclination angle of the first cutter in the circumferential direction of the holder.

4. A cutting tool comprising a holder, a first cutter, and a second cutter, the first cutter and the second cutter being attached to the holder, wherein
assuming that a direction perpendicular to a vertical direction in which a side of the cutting tool that is coupled to a drive mechanism corresponds to an upper side of the cutting tool is a horizontal direction, an amount of projection of the first cutter that projects substantially in the horizontal direction from the holder is greater than an amount of projection of the second cutter that projects substantially in the horizontal direction from the holder, and
a guide pad is attached to the holder in the vicinity of the second cutter so that a rotation axis of the cutting tool is disposed at substantially the same position as a center-of-gravity position of a horizontal section of the holder during cutting of an object to be cut while rotating the holder.

5. The cutting tool according to claim 1, wherein
the cutting tool includes an adjustment mechanism to adjust an amount of projection of the first cutter from the holder, and
the cutting tool includes no adjustment mechanism to adjust an amount of projection of the second cutter from the holder.
